(19) United States
(12) Patent Application Publication
(10) Pub. No.: US 2005/0036496 A1
(43) Pub. Date: Feb. 17, 2005

(54) Method for guaranteeing quality of service on the internet by routing data along nodes without error correction processing capability

(76) Inventor: Bob Tang, London (GB)

Correspondence Address: Bob Tang, Flat 1 136 Fellows Road, Swiss Cottage, NW3 3JH, GB

(21) Appl. No.: 10/472,060

(22) PCT Filed: Mar. 19, 2002
(86) PCT No.: PCT/GB02/01346

(30) Foreign Application Priority Data
Mar. 19, 2001 (GB) 0106572.1
Mar. 20, 2001 (GB) 0106991.3

(51) Int. Cl. H04L 12/28

(52) U.S. Cl. 370/395.21; 370/389

(57) ABSTRACT

This simple ready method routes all data (eg IP packets/ATM cell) between source and destination only along non-blocking links of router nodes on the Internet without data portion checksum processing at the nodes (eg using Real time Streaming Protocol IPv4 UDP packet type with checksum disabled; or as IPv6 specified hops UDP packets which has checksum included in the data portion but routed only along cut-through router/switches). The IP Packet here is sent without error correction checksum in the data portion, or the nodes along the route do not perform any error controls on the data portions of the IP Packets/ATM cells. Hence there will not be any IP Packets/ATM cells retransmissions occurrence along the route. IP Packets/ATM Cells with Header portion checksum errors detected could simply be discarded.

At present to facilitate multimedia/voice/fax/realtime applications on the Internet requires the IP packets to be given priority over other packets by methods such as RSVP/Tag Switching/guaranteed QoS ATM flow etc to ensure Quality of Service. However, the lack of interoperable standards means that the promised ability of some IP technologies to support these value-added services is not yet fully realised. Only a very small percentage of the routers/switches on the Internet at present are ATM router/switches.

Here is described a simple ready method enabling multimedia/voice/fax/realtime applications with similar end to end reception qualities on the present existing Internet Infrastructure Technology, and present existing protocols, without requiring RSVP/Tag Switching/guaranteed QoS ATM flow etc to ensure Quality of Service. Real Time Data may be transmitted over present existing Internet infrastructure, using present existing protocols, over the Internet to a wider number of Internet users.

This simple ready method routes all data (eg IP packets/ATM cell) between source and destination only along non-blocking links of router nodes on the Internet without data portion checksum processing at the nodes (eg using Real time Streaming Protocol IPv4 UDP packet type with checksum disabled, or as IPv6 specified hops UDP packets which has checksum included in the data portion but routed only along cut-through router/switches). The IP Packet here is sent without error correction checksum in the data portion, or the nodes along the route do not perform any error controls on the Data portions of the IP Packets/ATM cells. Hence there will not be any IP Packets/ATM cells retransmissions occurrence along the route. IP Packets/ATM Cells with Header portion checksum errors detected could simply be discarded.

Not all incoming links of the nodes routed through need be non-blocking, as long as the links routed through between source and destination are non-blocking.

An Internet connectivity map/database can be set up allowing Internet users to access, query and obtain the routes satisfying above example criteria.

Each such non-blocking nodes along the route introduces a small fixed hardware port to port latency, say around 8-30 microseconds each; with a 20 hops route the total port to port latency will introduce around 160-600 microseconds minimum delay to the supposed wire-speed source to destination data transmissions which we want to achieve.

For movies and telephony applications, delay of less than 0.02 second does not cause noticable impairment to the perception qualities. Voice PCM data may thus be conveniently transmitted as IP packet as in present existing practise, but routed as above only along non-blocking links of router/switches nodes on the Internet.

Here very close approximation to wire-speed transmissions is achieved. The example extra 160-600 microseconds delay in end to end transmissions will not be cause noticable perception impairment to end users.

As an example, to ensure the IP packets/ATM cells etc are routed as in above examples, the periodically sampled data may be transmitted from the source as deterministic (ie always follow the same fixed path) unicast IP packets/ATM cells, eg using Real Time Streaming Protocol IPv4 UDP packet type with checksum disabled or as IPv6 specified hops UDP packets which has checksum included in the data portion but routed only along cut-through router/switches.

The Movies interframes/voice PCM inter-samples received at destination PC, transmitted using this simple method, would exhibit very minimal inter-packet arrivals jitters, enabling Cinema quality viewing of real time Internet streaming and very similar to PSTN quality Internet telephony.

Its noted here that the Last Mile could be DSL; or special non-blocking dial-up link port implemented, eg by end user's ISP provisioning sufficient switching processing capacity.

Limited blocking links may also be selected between the source and destination, eg Head of Line blocking could be tolerated where any delay encountered would only be for the very finite duration for the router/switch to complete its pre-existing forwarding operation on a single IP Packet/ATM Cell, from each of the node's incoming links, if any, onwards along the same outgoing link. Or eg where the individual nodes traversed is a Store & Forward router/switches or Cut-Through router/switches but where the data here is sent as Priority IP Packet/Priority ATM cell with priority in processing over any other non-priority IP Packets/ATM cells already in the queue buffer, each of the nodes imposes traffic management with neighbours ensuring that the sum of priority traffic from various preceding incoming links at any time does not exceed the available outgoing link bandwidths/switch processing, capacity. [An example of priority IP Packet: the Type of Service (TOS) fields in IP Header allows an originating host to request different classes of service for packets it transmits.]

The above-described embodiments merely illustrate the principles of the invention. Those skilled in the art may make various modifications and changes that will embody the principles of the invention and fall within the spirit and scope thereof

1. A method for routing data (eg IP Packets/ATM cells) between any source and destination on the Internet/WAN/Intranet, said method route data (eg IP Packets/ATM cells) by selecting only non-blocking links of router/switches nodes for forwarding of the data between source and destination on the Internet/WAN/Intranet.

2. A method for routing data (eg IP Packets/ATM cells) between source and destination on the Internet/WAN/Intranet, said method route data (eg IP Packets/ATM cells) by selecting only non-blocking, and/or limited blocking links, of router/switches nodes for forwarding of the data between source and destination on the Internet/WAN/Intranet.

3. A Method as in Method 2 above, where the only limited blocking of the link can arise only from Head-of-Line blocking, the delay encountered hence is only for the very finite limited duration for the router/switches to complete pre-existing forwarding operation on the single IP Packet/ATM Cell, from each of the node's preceding incoming links, if any, onwards along the same outgoing link.

4. A Method as in Methods 1 or 2 or 3 above, where the individual router/switches nodes traversed may be a Store & Forward router/switches or Cut Through router/switches, here the data (eg IP Packets/ATM cells) is sent as Priority IP Packets/ATM cells with immediate priority in processing over any other non-priority IP Packets/ATM cells already in the queue buffer; each of the nodes imposes traffic management with neighbours ensuring that the sum of such priority traffic from various preceding incoming links at any time does not exceed the available outgoing link bandwidths/switch processing capacity.

5. A Method as in Methods 1 or 2 or 3 or 4 above, said Method route the data (eg IP Packets/ATM cells) along nodes without data portion checksum processing at the nodes hence there will not be any IP Packets/ATM Cells retransmissions occurrence on IP Packets/ATM Cells data portion checksum errors between any of the neighbouring router/switches nodes along the route.

6. A Method as in Method 5 above, said Method route the data (eg IP Packets/ATM cells) along nodes using, eg Real Time Streaming Protocol, IPv4 UDP packet type with checksum disabled; or eg IPv6 specified hops IP/UDP Packets which has checksum included in the data portion but routed only along cut-through router/switches: where the IP/UDP Packets/ATM Cells here are sent without error correction checksum in the data portion, or the nodes along the route do not perform any error controls on the data portions of the IP/UDP Packets/ATM cells.

7. A Method as in any of the preceding Methods above, said Method has an Internet connectivity map/database set up allowing Internet users to access, query and obtain the source to destination routes meeting the requirements of any of the preceding Methods.

8. A Method as in any of the preceding Methods above, said Method has a special non-blocking dial-up link port implemented in the end users last-mile access, eg by end user's ISP provisioning of sufficient switching processing capacity.
